(19) United States
(12) Patent Application Publication
(10) Pub. No.: US 2026/0119295 A1
(43) Pub. Date: Apr. 30, 2026

(54) MULTI-ACCESS EDGE COMPUTING SYSTEM HAVING FAULT PREVENTION FUNCTION AND METHOD FOR PREVENTING FAILURE THEREOF

(71) Applicant: KOREA RAILROAD RESEARCH INSTITUTE, Uiwang-si (KR)

(72) Inventors: Seongho KWON, Seoul (KR); Ilmu BYUN, Gunpo-si (KR); Youngjoo KIM, Hwaseong-si (KR); Sungsoo PARK, Seongnam-si (KR); Jonghun HAN, Gwacheon-si (KR)

(73) Assignee: KOREA RAILROAD RESEARCH INSTITUTE, Uiwang-si (KR)

(21) Appl. No.: 19/267,040

(22) Filed: Jul. 11, 2025

(30) Foreign Application Priority Data
Oct. 28, 2024 (KR) 10-2024-0148824

(51) Int. Cl. G06F 11/07; G06F 11/14

(52) U.S. Cl. CPC G06F 11/0751; G06F 11/1482

(57) ABSTRACT

A multi-access edge computing (MEC) system includes a first MEC service unit, a second MEC service unit, a third MEC service unit, and a fault-tolerant system. The first MEC service unit includes a main service application as the primary provider of a service. The second MEC service unit includes a first replicated service application as a backup in case of a fault in the main service application. The third MEC service unit includes a second replicated service application as a backup in case of a fault in the main service application. The fault-tolerant system includes a fault detection unit for detecting whether a fault has occurred in the main service application, and a fault adjustment unit for determining whether to replace the functionality of the main service application with one of the first or second replicated service applications in the event of a failure in the main service application.

### CROSS-REFERENCE TO RELATED APPLICATIONS

This application claims priority under 35 U.S.C. § 119 to Korean Patent Application No. 10-2024-0148824, filed on Oct. 28, 2024 in the Korean Intellectual Property Office (KIPO), the contents of which are herein incorporated by reference in their entirety.

### BACKGROUND OF THE INVENTION

### Technical Field

Exemplary embodiments of the present invention relate to a multi-access edge computing system having a failure prevention function and a method for preventing failure the multi-access edge computing system. More particularly, exemplary embodiments of the present invention relate to a multi-access edge computing system having fault prevention function configured to prevent inoperability due to the occurrence of a fault and a method for preventing failure of the multi-access edge computing system.

### Discussion of the Related Art

Multi-access edge computing (MEC) is a technology and system that processes computing tasks at the edge of a network. MEC is primarily used in 5G and Internet of Things (IoT) environments, enabling data to be processed at the nearest point of the network (e.g., local cloud) before being sent to a central cloud or server. This approach reduces latency, optimizes bandwidth usage, and enhances the performance of applications that require real-time responses, such as autonomous vehicles, smart factories, and augmented reality.

MEC processes data at the edge of the network, rather than sending it to a central server, which significantly reduces response time. Additionally, MEC helps reduce bandwidth usage by minimizing network traffic, as data is processed locally. MEC's real-time processing capabilities are particularly beneficial for applications that require immediate analysis and decision-making. Furthermore, by distributing computing resources at the network edge, MEC enables efficient data processing. As 5G continues to evolve, MEC is becoming an increasingly critical technology, especially in fields such as industrial automation, healthcare, and smart cities.

### SUMMARY

Exemplary embodiments of the present invention provide a multi-access edge computing system having a failure prevention function configured to prevent inoperability due to failure even if a failure occurs when a service application (MEC app), which is a main service provider, is executed.

Exemplary embodiments of the present invention also provide a method for preventing a failure of the above-described multi-access edge computing system.

According to one aspect of the present invention, a multi-access edge computing (MEC) system with fault-tolerant functionality, which enhances the performance of applications and services by deploying computing resources at the edge of the network, includes a first MEC service unit, a second MEC service unit, a third MEC service unit, and a fault-tolerant system. The first MEC service unit includes a main service application, which acts as the primary provider of a service. The second MEC service unit includes a first replicated service application, which acts as a backup in case of a fault in the main service application. The third MEC service unit includes a second replicated service application, which acts as a backup in case of a fault in the main service application. The fault-tolerant system includes a fault detection unit for detecting whether a fault has occurred in the main service application, and a fault adjustment unit for determining whether to replace the functionality of the main service application with one of the first or second replicated service applications in the event of a failure in the main service application.

In an exemplary embodiment of the present invention, the first MEC service unit may further include a first MEC server to which input packets are provided, a first hypervisor connected to the first MEC server, and a first operating system (OS) connected to the first hypervisor. Here, the main service application is connected to the first operating system (OS).

In an exemplary embodiment of the present invention, the second MEC service unit may further include a second MEC server to which the input packet is provided, a second hypervisor connected to the second MEC server, and a second operating system (OS) connected to the second hypervisor. Here, the first replicated service application is connected to the second operating system (OS).

In an exemplary embodiment of the present invention, the third MEC service unit may further include a third MEC server to which the input packet is provided, a third hypervisor connected to the third MEC server, and a third operating system (OS) connected to the third hypervisor. Here, the second replicated service application is connected to the third operating system (OS).

In an exemplary embodiment of the present invention, the fault detection unit receives an input packet mirrored from the input packets, an MEC server packet 1 provided through the first MEC server, an MEC server packet 2 provided through the second MEC server, and an MEC server packet 3 provided through the third MEC server, and detects whether a failure has occurred to notify the fault adjustment unit.

According to another aspect of the present invention, there is provided a method for preventing faults in a multi-access edge computing (MEC) system with fault-tolerant functionality, which enhances the performance of applications and services by deploying computing resources at the edge of the network. In the method, it is detected whether a failure has occurred in a primary service application. It is determined whether to substitute the function of the primary service application with either a first replicated service application or a second replicated service application upon detection of a fault in the primary service application.

In an exemplary embodiment of the present invention, the detecting the fault may include: checking whether the receiver IP address of a mirrored input packet matches the sender IP address of MEC server packet 1 provided via a first MEC server; determining that a fault has occurred, setting a variable “F” to 1 to indicate the fault, and terminating the fault detection process when the receiver IP address of the mirrored input packet does not match the sender IP address of MEC server packet 1; checking whether the delay of MEC server packet 1 is within a threshold set by a user, when the receiver IP address of the mirrored input packet matches the sender IP address of MEC server packet 1; providing feedback to the step of determining failure when the delay of MEC server packet 1 is found to be outside the aforementioned threshold; checking whether the requested data in the mirrored input packet matches the data format of MEC server packet 1, when the delay of MEC server packet 1 is found to be within the above-mentioned threshold; and providing feedback to the step of determining failure when the requested data of the mirrored input packet and the data format of MEC server packet 1 are found to be different.

In an exemplary embodiment of the present invention, the delay may be defined as the time difference between the mirrored input packet and MEC server packet 1.

In an exemplary embodiment of the present invention, detecting the fault may further include: checking whether the receiver IP address of the mirrored input packet matches the sender IP address of MEC server packet 2 provided via a second MEC server, when the data format of a request in the mirrored input packet is determined to be the same as the data format of MEC server packet 1; providing feedback to the step of determining a fault when the receiver IP address of the mirrored input packet does not match the sender IP address of MEC server packet 2; checking whether the delay of MEC server packet 2 is within a threshold set by a user, when the receiver IP address of the mirrored input packet matches the sender IP address of MEC server packet 2; providing feedback to the step of determining a fault when the delay of MEC server packet 2 is found to be outside the threshold; checking whether the data format of the request in the mirrored input packet is the same as the data format of MEC server packet 2, when the delay of MEC server packet 2 is within the threshold; and providing feedback to the step of determining a fault when the data formats of the mirrored input packet and MEC server packet 2 do not match.

In an exemplary embodiment of the present invention, the delay may be defined as the time difference between the mirrored input packet and MEC server packet 2.

In an exemplary embodiment of the present invention, detecting the fault may further include: checking whether the receiver IP address of the mirrored input packet matches the sender IP address of MEC server packet 3 provided via a third MEC server, when the data format of a request in the mirrored input packet is determined to be the same as the data format of MEC server packet 2; providing feedback to the step of determining a fault when the receiver IP address of the mirrored input packet does not match the sender IP address of MEC server packet 3; checking whether the delay of MEC server packet 3 is within a threshold set by a user, when the receiver IP address of the mirrored input packet matches the sender IP address of MEC server packet 3; providing feedback to the step of determining a fault when the delay of MEC server packet 3 is found to be outside the threshold; checking whether the data format of the request in the mirrored input packet is the same as the data format of MEC server packet 3, when the delay of MEC server packet 3 is within the threshold; providing feedback to the step of determining a fault when the data formats of the mirrored input packet and MEC server packet 3 do not match; and setting the variable “F” to 0 and terminating the fault detection operation when the data formats are determined to be the same, thereby concluding that no fault has occurred.

In an exemplary embodiment of the present invention, the delay may be defined as the time difference between the mirrored input packet and MEC server packet 3.

In an exemplary embodiment of the present invention, adjusting the fault may include: checking whether a variable “F” indicating a fault is equal to 1; setting an output packet to a first MEC server packet provided via a first MEC server, when “F” is not equal to 1; performing a voting algorithm when “F” is equal to 1; checking whether the delay of a second MEC server packet provided via a second MEC server is less than the delay of a third MEC server packet provided via a third MEC server; setting “N” to 2, when the delay of the second MEC server packet is less than the delay of the third MEC server packet; setting “N” to 3, when the delay of the second MEC server packet is not less than the delay of the third MEC server packet; and setting the output packet to MEC server packet “N”.

According to some exemplary embodiments of the present invention, in addition to the first MEC service unit including the main service application, which is the main service provider, a second MEC service unit including the first replication service application and a third MEC service unit including the second replication service application are configured separately, and when the main service application fails, the function of the main service application is replaced with one of the separately configured first replication service application and the second replication service application to prevent the inoperability due to the failure from occurring even if a failure occurs when the service application is executed.

### BRIEF DESCRIPTION OF THE DRAWINGS

The above and other features and aspects of the present invention will become more apparent by describing in detailed exemplary embodiments thereof with reference to the accompanying drawings, in which:

FIG. 1 is a diagram for explaining an MEC structure;

FIG. 2 is a block diagram illustrating a multi-access edge computing system having a fault prevention function according to an exemplary embodiment of the present invention;

FIG. 3 is a block diagram for explaining the fault-tolerant system shown in FIG. 2;

FIG. 4A, FIG. 4B, and FIG. 4C are flowcharts for explaining a fault detection algorithm of the fault-tolerant system shown in FIG. 2; and

FIG. 5 is a flowchart for explaining a fault adjustment algorithm of the fault-tolerant system shown in FIG. 2.

### DETAILED DESCRIPTION OF THE INVENTION

The present invention is described more fully hereinafter with reference to the accompanying drawings, in which exemplary embodiments of the present invention are shown. The present invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the invention are described herein with reference to cross-sectional illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be explained in detail with reference to the accompanying drawings.

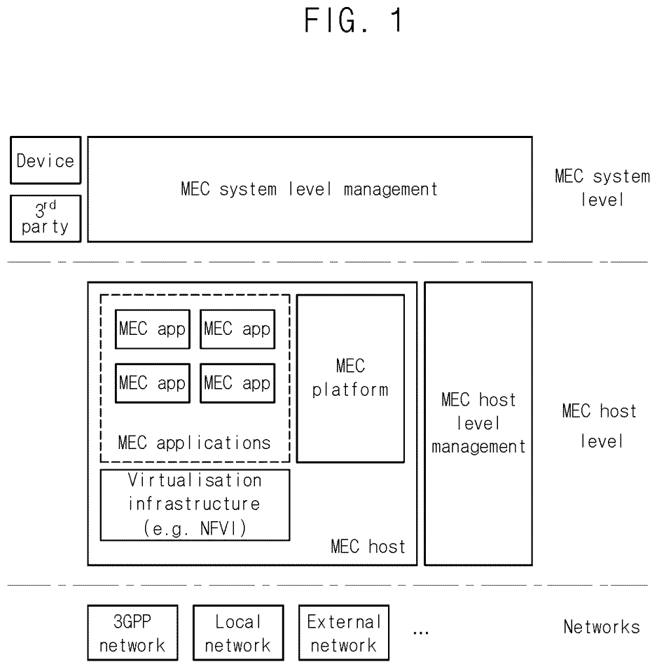

FIG. 1 is a diagram for explaining an MEC structure. In particular, the standard structure under development at ESTI is illustrated.

Referring to FIG. 1, a network level entity includes connectivity to external networks such as local area networks, mobile communication networks, and the Internet. Expanding the above connectivity to include non-mobile communication networks is the main goal of current MEC activities.

A MEC host level is a location where a MEC host is situated together with the associated management sub-systems. The MEC host may include a platform on which an application is executed and a virtualization infrastructure.

A MEC system level management maintains a global view of the entire MEC system. That is, it represents a set of management subsystems related to the MEC host.

The MEC host on the MEC host level is a logical structure that includes a MEC platform and a virtualization infrastructure that may provide computing, storage, and network resources to MEC applications. The MEC platform within the MEC host includes a set of essential functionalities required to execute an application on the MEC host and to enable the MEC application to discover, advertise, provide, and consume MEC services.

The MEC applications within the MEC host include a plurality of service applications (MEC apps) and are executed as virtual machines on the virtualization infrastructure provided by the MEC host. The service application (MEC app) interacts with the MEC platform to process the MEC services available on the MEC host. In practice, a service application (MEC app) not only consumes MEC services, but also may provide them to the MEC platform, making them available to other applications.

However, the determination of failures during the execution of a service application (MEC app) may be limited. For example, it is possible to verify whether the service application is running or whether the MEC server is operational through a ‘heartbeat’ signal, but it is not possible to precisely identify where the failure occurred. Additionally, no functionality is provided to prevent such failures when they occur.

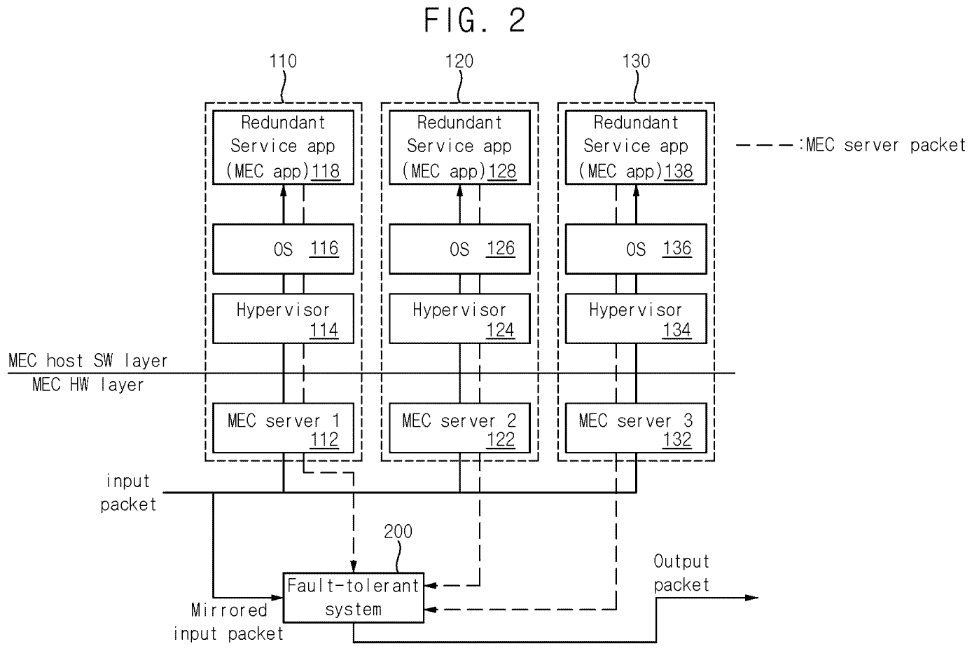

A modified MEC structure having a failure prevention function, as shown in FIG. 2, may be proposed by classifying the MEC host in FIG. 1 as software and the network and sub-devices as hardware.

FIG. 2 is a block diagram illustrating a multi-access edge computing system having a fault prevention function according to an exemplary embodiment of the present invention.

Referring to FIG. 2, the multi-access edge computing system having a failure prevention function according to an exemplary embodiment of the present invention includes a first MEC service unit 110, a second MEC service unit 120, a third MEC service unit 130, and a fault-tolerant system 200. In the present embodiment, the first MEC service unit 110 may be used as a main body. When the first MEC service unit 110 is identified as having failed by the fault-tolerant system 200, the fault-tolerant system 200 adjusts the second MEC service unit 120 or the third MEC service unit 130 to be used.

The first MEC service unit 110 may include a first MEC server 112, a first hypervisor 114 connected to the first MEC server 112, a first operating system (OS) 116 connected to the first hypervisor 114, and a main service application 118 connected to the first OS 116.

Specifically, the first MEC server 112 may be disposed on the MEC hardware layer, and may be located at an edge location close to a user for data processing, thereby reducing delay time and improving performance. The first hypervisor 114, the first OS 116, and the main service application (MEC app) 118 may be disposed on the MEC host software layer. The MEC host software layer may provide a software environment operating on the MEC hardware, so that each server and application cooperates efficiently with each other while operating independently. The first hypervisor 114 may be software that enables multiple operating systems to be executed simultaneously using virtualization technology. The first hypervisor 114 may create and manages a virtual machine (VM). The first OS 116 may be an operating system managed by the first hypervisor 114. The main service application (MEC app) 118 may be an application running on the first OS 116 and performs the function of the MEC server. The main service application (MEC app) 118 mainly performs functions such as data processing and network management.

The second MEC service unit 120 may include a second MEC server 122, a second hypervisor 124 connected to the second MEC server 122, a second OS 126 connected to the second hypervisor 124, and a first replication service application 128 connected to the second OS 126.

Specifically, the second MEC server 122 may be disposed on the MEC hardware layer, and may be located at an edge location close to a user for data processing, thereby reducing delay time and improving performance. The second MEC server 122 may be disposed to be physically separated from the first MEC server 112. The second hypervisor 124, the second OS 126, and the first replication service application 128 may be disposed on the MEC host software layer. The second hypervisor 124 may provide an independent virtual environment. The second OS 126 is the second operating system managed by the second hypervisor 124. The first replication service application (MEC app) 128 may be an application that runs on the second OS 126, and mainly provides redundancy so that service may be continued when a failure occurs.

The third MEC service unit 130 may include a third MEC server 132, a third hypervisor 134 connected to the third MEC server 132, a third OS 136 connected to the third hypervisor 134, and a second replication service application 138 connected to the third OS 136.

Specifically, the third MEC server 132 may be disposed on the MEC hardware layer, and may be located at an edge location close to the user for data processing, thereby reducing delay time and improving performance. The third MEC server 132 may be disposed to be physically separated from the first MEC server 112 and the second MEC server 122. The third hypervisor 134, the third OS 136, and the second replication service application 138 may be disposed on the MEC host software layer. The third hypervisor 134 may provide an additional virtual environment. The third OS 136 may be the third operating system managed by the third hypervisor 134. The second replication service application (MEC app) 138 may be an application running on the third OS 136 and provides service redundancy similar to the first replication service application 128.

The fault-tolerant system 200 may be disposed on the MEC hardware layer. The fault-tolerant system 200 determines whether a fault occurs by analyzing a packet of the main service application 118 provided in the first MEC service unit 110 and a packet of the first replica service application 128 provided in the second MEC service unit 120 and a packet of the second replica service application 138 provided in the third MEC service unit 130. When the main service application 118 provided in the first MEC service unit 110 is determined to be a fault, the fault-tolerant system 200 determines one of the first replica service application 128 and the second replica service application 138 as an output packet.

In FIG. 2 of the present embodiment, an example assuming that one service is performed is shown. That is, a case of executing one main service application (service app/MEC app) 118 is shown. Two replication service applications that perform the same function as the main service application 118 but are installed and driven on another physically separated MEC server are present.

The main service application 118 may be a main service provider. When the main service application 118 is determined to be a failure, the function of the main service application 118 determined to be a failure may be performed by one of the first replication service application 128 and the second replication service application 138.

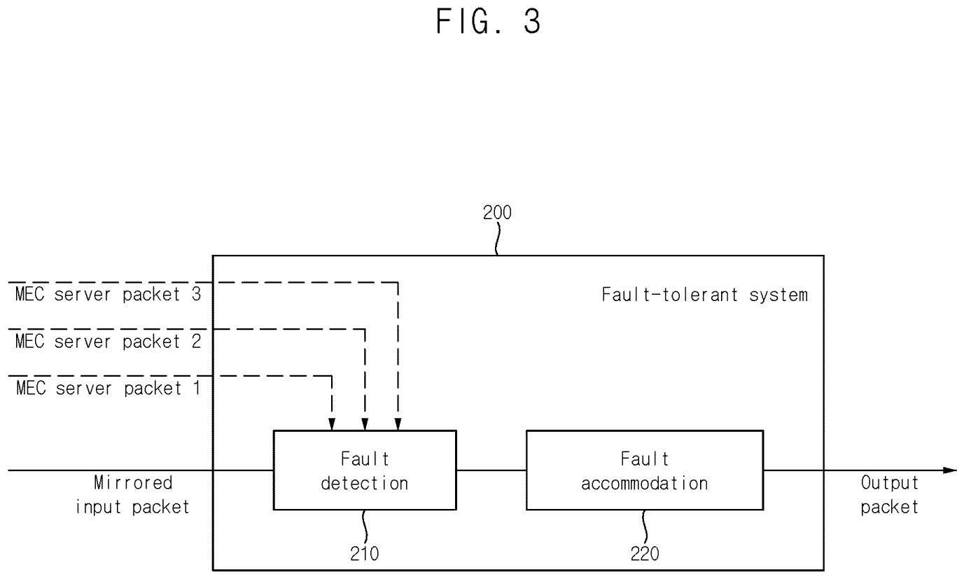

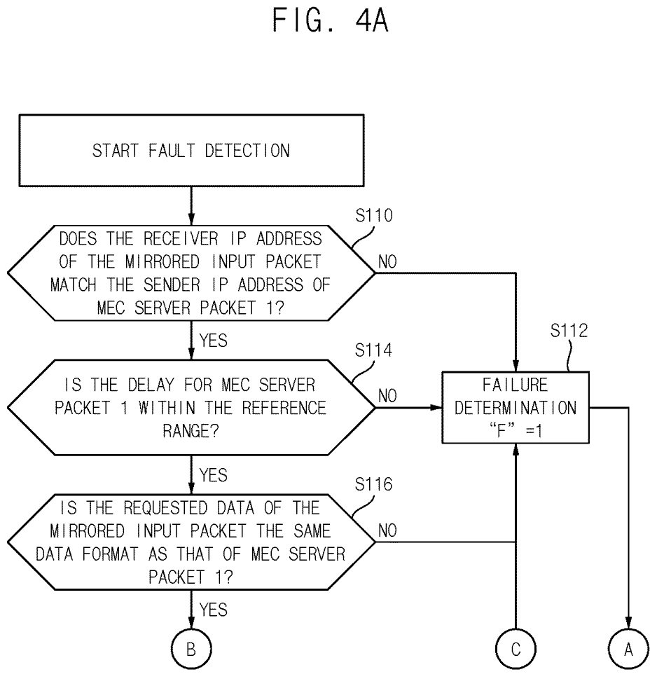

FIG. 3 is a block diagram for explaining the fault-tolerant system 200 shown in FIG. 2.

Referring to FIG. 2 and FIG. 3, the fault-tolerant system 200 includes a failure detection unit 210 and a failure adjustment unit 220.

The failure detection unit 210 receives the mirrored input packet, the MEC server packet 1 via the first MEC server 112, the MEC server packet 2 via the second MEC server 122, and the MEC server packet 3 via the third MEC server 132 to detect whether a failure has occurred and notify the failure adjustment unit 220. Here, the MEC server packet 1 is output from the main service application 118, and is provided to the failure detection unit 210 via the first OS 116, the first hypervisor 114, and the first MEC server 112. The MEC server packet 2 is also output from the first replication service application 128, and is provided to the failure detection unit 210 via the second OS 126, the second hypervisor 124, and the second MEC server 122. In addition, the MEC server packet 3 is output from the second replication service application 138, and is provided to the failure detection unit 210 via the third OS 136, the third hypervisor 134, and the third MEC server 132.

The failure adjustment unit 220 determines that the first replication service application 128 or the second replication service application 138 may replace the function of the main service application 118 when a failure occurs.

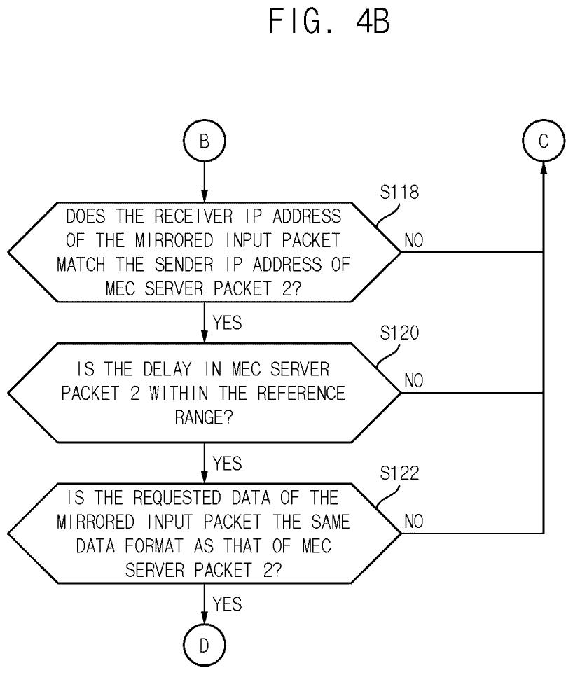

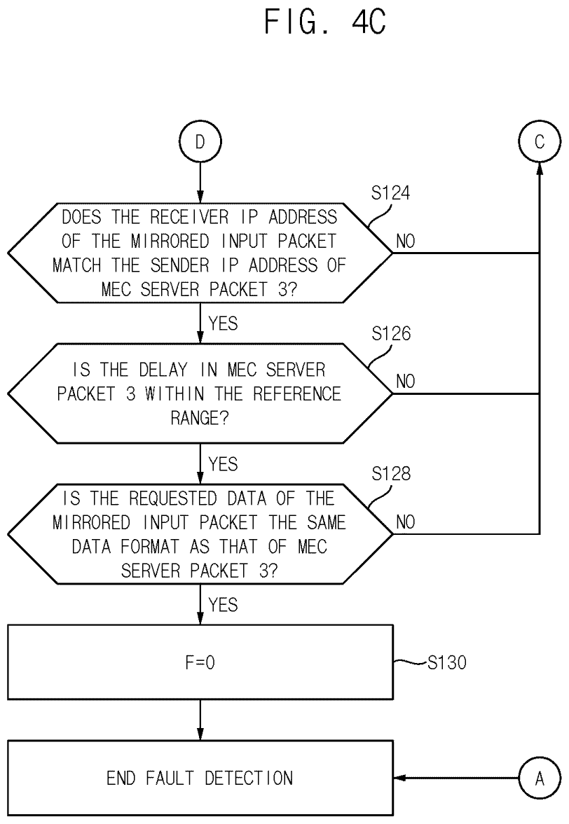

A fault detection algorithm performed by the fault detection unit 210 shown in FIG. 3 is as shown in FIG. 4A, FIG. 4B, and FIG. 4C.

FIG. 4A, FIG. 4B, and FIG. 4C are flowcharts for explaining a fault detection algorithm of the fault-tolerant system 200 shown in FIG. 2.

Referring to FIG. 3 to FIG. 4C, whether the receiver IP address of the mirrored input packet matches the sender IP address of MEC server packet 1 is checked (step S110).

When the receiver IP address of the mirrored input packet is not checked to match the sender IP address of the MEC server packet 1 in step S110, it is determined as a failure and a variable “F” indicating a failure is set to 1 (step S112), and then the failure detection operation is terminated.

When the receiver IP address of the mirrored input packet is checked to match the sender IP address of the MEC server packet 1 in step S110, it is checked whether the delay of the MEC server packet 1 (i.e., the time difference between the mirrored input packet and the MEC server packet 1) is within a reference range set by the user (step S114).

When the delay of the MEC server packet 1 is not checked to be within the reference range in step S114, the process returns to step S112 of determining that it is a failure.

When the delay of the MEC server packet 1 is checked to be within the reference range in step S114, it is checked whether the requested data of the mirrored input packet is the same as the data format of the MEC server packet 1 (step S116).

When it is checked that the requested data of the mirrored input packet and the data format of the MEC server packet 1 are not the same in step S116, the process returns to step S112 of determining that it is a failure.

When the requested data of the mirrored input packet and the data format of the MEC server packet 1 are checked to be the same in step S116, it is checked whether the receiver IP address of the mirrored input packet matches the sender IP address of the MEC server packet 2 (step S118).

When the receiver IP address of the mirrored input packet is not checked to match the sender IP address of the MEC server packet 2 in step S118, the process returns to step S112 of determining that it is a failure.

When the receiver IP address of the mirrored input packet is checked to match the sender IP address of the MEC server packet 2 in step S118, it is checked whether the delay of the MEC server packet 2 is within the reference range (step S120).

When the delay of the MEC server packet 2 is not checked to be within the reference range in step S120, the process returns to step S112 of determining that it is a failure.

When the delay of the MEC server packet 2 is checked to be within the reference range in step S120, it is checked whether the requested data of the mirrored input packet is the same as the data format of the MEC server packet 2 (step S122).

When the requested data of the mirrored input packet and the data format of the MEC server packet 2 are not checked to be the same in step S122, the process returns to step S112 of determining that it is a failure.

When the requested data of the mirrored input packet and the data format of the MEC server packet 2 are checked to be the same in step S122, it is checked whether the receiver IP address of the mirrored input packet matches the sender IP address of the MEC server packet 3 (step S124).

In step S124, when the receiver IP address of the mirrored input packet is not checked to match the sender IP address of the MEC server packet 3, the process returns to step S112 of determining that it is a failure.

When the receiver IP address of the mirrored input packet is checked to match the sender IP address of the MEC server packet 3 in step S124, it is checked whether the delay of the MEC server packet 3 is within the reference range (step S126).

When the delay of the MEC server packet 3 is not checked to be within the reference range in step S126, the process returns to step S112 of determining that it is a failure.

When the delay of the MEC server packet 3 is checked to be within the reference range in step S126, it is checked whether the requested data of the mirrored input packet is the same as the data format of the MEC server packet 3 (step S128).

When the requested data of the mirrored input packet and the data format of the MEC server packet 3 are not checked to be the same in step S128, the process returns to step S112 of determining that it is a failure.

When the requested data of the mirrored input packet and the data format of the MEC server packet 3 are checked to be the same in step S128, it is determined that a failure has not occurred and set F=0 (step S130), and the failure detection operation is terminated.

As described above, the failure detection unit 210 may perform a failure detection procedure that determines whether a failure occurs by comparing the receiver IP address of the mirrored input packet with the sender IP address of the MEC server packet. That is, the failure detection unit 210 may be a process of checking the IP address, and when the receiver IP of the mirrored input packet does not match the sender IP of the MEC server packet 1, it is regarded as a failure, sets “F” to 1, and ends the failure detection. Subsequently, as part of the delay checking process, the fault detection unit 210 checks whether the delay of MEC server packet 1 is within the reference range when the receiver IP of the mirrored input packet matches the sender IP of MEC server packet 1. When it is not within the reference range, it determines that a fault has occurred. Subsequently, the failure detection unit 210 is a process of comparing the data formats, and when the delay is within the reference range, the requested data and the data formats of the MEC server packet 1 are compared. The failure detection unit 210 repeatedly checks the IP address, checks the delay, and compares the data formats for the MEC server packet 2 and the MEC server packet 3. When all the checks are passed, the failure detection unit 210 determines that a failure has not occurred, sets “F” to 0, and ends the failure detection.

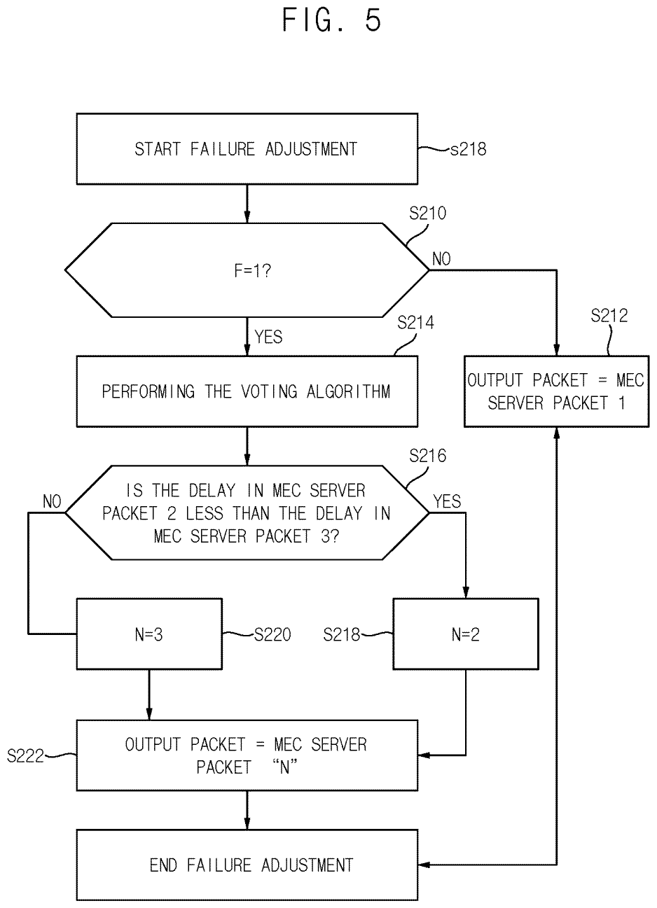

On the other hand, a fault accommodation algorithm performed by the fault control unit 220 shown in FIG. 3, that is, a fault accommodation algorithm that determines that the replication service application can replace the function of the main service application 118 when a fault occurs, is as shown in FIG. 5.

FIG. 5 is a flowchart for explaining a fault adjustment algorithm of the fault-tolerant system 200 shown in FIG. 2.

Referring to FIG. 3 and FIG. 5, as a failure adjustment starts, whether a variable “F” indicating a failure is 1 is checked (step S210).

In step S210, when “F” is not checked to be 1, an output packet is set to MEC server packet 1 (step S212), and then a failure adjustment operation is terminated.

When “F” is checked to be 1 in step S210, a voting algorithm is performed to determine how different a result of a main service application 118 is through data comparison between the main service application 118 and a replication service application (step S214). Here, the voting algorithm is a technology used in the field of safety systems and industrial control, and to determine whether a function of the main system (the main service application 118 in FIG. 2) is normal, it is a technology that can compare data with the replication system (the replication service application in FIG. 2) to determine how different the main system is from other replication systems.

Subsequently, whether the delay of the MEC server packet 2 is smaller than the delay of the MEC server packet 3 is checked (step S216).

When the delay of the MEC server packet 2 is checked to be smaller than the delay of the MEC server packet 3 in step S216, “N” is set to 2 (step S218).

When it is checked that the delay of the MEC server packet 2 is not smaller than the delay of the MEC server packet 3 in step S216, “N” is set to 3 (step S220).

Following the step S218 or following the step S220, after setting the output packet as the MEC server packet “N” (step S222), the failure adjustment operation is terminated.

As described above, the failure adjustment unit 220 performs a failure check operation to check whether a variable “F” indicating a state of the system is 1. When “F” is not 1, the failure adjustment unit 220 determines that a failure has not occurred, outputs the MEC server packet 1, and ends failure adjustment. When “F” is 1, the failure adjustment unit 220 executes a voting algorithm to check whether the system operates normally, and this process compares data between the main service application 118 and the replication service application to determine how different the results of the main service application 118 are. After the voting algorithm, the failure adjustment unit 220 compares the delay of the two MEC server packets with “N” When the delay of the MEC server packet 2 is shorter than the packet 3, and When not, “N” is set to 3. Finally, the failure adjustment unit 220 determines the output packet according to the set “N” and ends the failure adjustment.

As described above, according to the present invention, in addition to the first MEC service unit including the main service application, which is the main service provider, the second MEC service unit including the first replication service application and the third MEC service unit including the second replication service application are separately configured, and when the main service application fails, the function of the main service application is replaced with one of the separately configured first replication service application and the second replication service application to prevent the inoperability due to the failure from occurring even When a failure occurs when the service application is executed.

The foregoing is illustrative of the present invention and is not to be construed as limiting thereof. Although a few exemplary embodiments of the present invention have been described, those skilled in the art will readily appreciate that many modifications are possible in the exemplary embodiments without materially departing from the novel teachings and advantages of the present invention. Accordingly, all such modifications are intended to be included within the scope of the present invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific exemplary embodiments disclosed, and that modifications to the disclosed exemplary embodiments, as well as other exemplary embodiments, are intended to be included within the scope of the appended claims. The present invention is defined by the following claims, with equivalents of the claims to be included therein.

What is claimed is:

1. A multi-access edge computing (MEC) system with fault-tolerant functionality, which enhances the performance of applications and services by deploying computing resources at the edge of the network, comprising:
a first MEC service unit comprising a main service application, which acts as the primary provider of a service;
a second MEC service unit comprising a first replicated service application, which acts as a backup in case of a fault in the main service application;
a third MEC service unit comprising a second replicated service application, which acts as a backup in case of a fault in the main service application; and
a fault-tolerant system comprising:
a fault detection unit for detecting whether a fault has occurred in the main service application; and
a fault adjustment unit for determining whether to replace the functionality of the main service application with one of the first or second replicated service applications in the event of a failure in the main service application.

2. The MEC system of claim 1, wherein the first MEC service unit further comprises:
a first MEC server to which input packets are provided;
a first hypervisor connected to the first MEC server; and
a first operating system (OS) connected to the first hypervisor;
wherein the main service application is connected to the first operating system (OS).

3. The MEC system of claim 2, wherein the second MEC service unit further comprises:
a second MEC server to which the input packet is provided;
a second hypervisor connected to the second MEC server; and
a second operating system (OS) connected to the second hypervisor;
wherein the first replicated service application is connected to the second operating system (OS).

4. The MEC system of claim 3, wherein the third MEC service unit further comprises:
a third MEC server to which the input packet is provided;
a third hypervisor connected to the third MEC server; and
a third operating system (OS) connected to the third hypervisor;
wherein the second replicated service application is connected to the third operating system (OS).

5. The MEC system of claim 4, wherein the fault detection unit receives an input packet mirrored from the input packets, an MEC server packet 1 provided through the first MEC server, an MEC server packet 2 provided through the second MEC server, and an MEC server packet 3 provided through the third MEC server, and detects whether a failure has occurred to notify the fault adjustment unit.

6. A method for preventing faults in a multi-access edge computing (MEC) system with fault-tolerant functionality, which enhances the performance of applications and services by deploying computing resources at the edge of the network, the method comprising:
detecting whether a failure has occurred in a primary service application; and
determining whether to substitute the function of the primary service application with either a first replicated service application or a second replicated service application upon detection of a fault in the primary service application.

7. The method of claim 6, wherein the detecting the fault comprises:
checking whether the receiver IP address of a mirrored input packet matches the sender IP address of MEC server packet 1 provided via a first MEC server;
determining that a fault has occurred, setting a variable “F” to 1 to indicate the fault, and terminating the fault detection process when the receiver IP address of the mirrored input packet does not match the sender IP address of MEC server packet 1;
checking whether the delay of MEC server packet 1 is within a threshold set by a user, when the receiver IP address of the mirrored input packet matches the sender IP address of MEC server packet 1;
providing feedback to the step of determining failure when the delay of MEC server packet 1 is found to be outside the aforementioned threshold;
checking whether the requested data in the mirrored input packet matches the data format of MEC server packet 1, when the delay of MEC server packet 1 is found to be within the above-mentioned threshold; and
providing feedback to the step of determining failure when the requested data of the mirrored input packet and the data format of MEC server packet 1 are found to be different.

8. The method of claim 7, wherein the delay is defined as the time difference between the mirrored input packet and MEC server packet 1.

9. The method of claim 7, wherein detecting the fault further comprises:
checking whether the receiver IP address of the mirrored input packet matches the sender IP address of MEC server packet 2 provided via a second MEC server, when the data format of a request in the mirrored input packet is determined to be the same as the data format of MEC server packet 1;
providing feedback to the step of determining a fault when the receiver IP address of the mirrored input packet does not match the sender IP address of MEC server packet 2;
checking whether the delay of MEC server packet 2 is within a threshold set by a user, when the receiver IP address of the mirrored input packet matches the sender IP address of MEC server packet 2;
providing feedback to the step of determining a fault when the delay of MEC server packet 2 is found to be outside the threshold;
checking whether the data format of the request in the mirrored input packet is the same as the data format of MEC server packet 2, when the delay of MEC server packet 2 is within the threshold; and
providing feedback to the step of determining a fault when the data formats of the mirrored input packet and MEC server packet 2 do not match.

10. The method of claim 9, wherein the delay is defined as the time difference between the mirrored input packet and MEC server packet 2.

11. The method of claim 9, wherein detecting the fault further comprises:
checking whether the receiver IP address of the mirrored input packet matches the sender IP address of MEC server packet 3 provided via a third MEC server, when the data format of a request in the mirrored input packet is determined to be the same as the data format of MEC server packet 2;
providing feedback to the step of determining a fault when the receiver IP address of the mirrored input packet does not match the sender IP address of MEC server packet 3;
checking whether the delay of MEC server packet 3 is within a threshold set by a user, when the receiver IP address of the mirrored input packet matches the sender IP address of MEC server packet 3;
providing feedback to the step of determining a fault when the delay of MEC server packet 3 is found to be outside the threshold;
checking whether the data format of the request in the mirrored input packet is the same as the data format of MEC server packet 3, when the delay of MEC server packet 3 is within the threshold;
providing feedback to the step of determining a fault when the data formats of the mirrored input packet and MEC server packet 3 do not match; and
setting the variable “F” to 0 and terminating the fault detection operation when the data formats are determined to be the same, thereby concluding that no fault has occurred.

12. The method of claim 11, wherein the delay is defined as the time difference between the mirrored input packet and MEC server packet 3.

13. The method of claim 6, wherein adjusting the fault comprises:
checking whether a variable “F” indicating a fault is equal to 1;
setting an output packet to a first MEC server packet provided via a first MEC server, when “F” is not equal to 1;
performing a voting algorithm when “F” is equal to 1;
checking whether the delay of a second MEC server packet provided via a second MEC server is less than the delay of a third MEC server packet provided via a third MEC server;
setting “N” to 2, when the delay of the second MEC server packet is less than the delay of the third MEC server packet;
setting “N” to 3, when the delay of the second MEC server packet is not less than the delay of the third MEC server packet; and
setting the output packet to MEC server packet “N”.
